(19) United States
(12) Patent Application Publication
(10) Pub. No.: US 2026/0254273 A1
(43) Pub. Date: Aug. 27, 2026

(54) INDUCTIVE CHARGING SYSTEM

(71) Applicant: Sundance Spas, Inc., Chino, CA (US)

(72) Inventors: Luke Allee, Costa Mesa, CA (US); Mark Knight, Venice, CA (US); Erica A. Langpeter Moir, Santa Ana, CA (US); Larry R. Ovalle, Glendora, CA (US)

(21) Appl. No.: 19/146,886

(22) PCT Filed: Jan. 10, 2024
(86) PCT No.: PCT/US2024/011021

§ 371 Date: Jul. 9, 2025

Related U.S. Application Data
(60) Provisional application No. 63/479,286, filed on Jan. 10, 2023.

(51) Int. Cl. H02J 50/10; A61H 33/00; H02J 7/70

(52) U.S. Cl. CPC H02J 50/10; A61H 33/6005; H02J 7/731

(57) ABSTRACT

An inductive charging system includes a spa shell, a charging region positioned on an exterior surface of the spa shell, and a charger. The charging region can be configured to receive an electronic device. The charger can include a charger housing and a charging pad, the charger housing configured to receive and secure the charging pad. The charger can be configured to be positioned on a rear side of the charging region opposite the electronic device. The charge can be further configured to be plugged into spa electronics for power. The charging pad can be configured to wirelessly charge the electronic device when the electronic device is positioned on the charging region.

### CROSS-REFERENCE TO RELATED APPLICATIONS

This application claims the benefit of U.S. Provisional Application No. 63/479,285, entitled “INDUCTIVE CHARGING SYSTEM” and filed on Jan. 10, 2023, which is hereby incorporated by reference in its entirety.

### TECHNICAL FIELD

The present invention relates generally to an inductive charging system for a spa unit or hot tub.

### BACKGROUND

Conventional chargers for electronic devices may not be suitable for use near water (e.g., spa units, hot tubs, swim spas, etc.) which can prevent access to a charger at or near a spa unit and/or hot tub. This may prevent users from using an electronic device for extended periods of time when using a spa unit and/or hot tub and require users to step out of the spa unit and/or hot tub to get access to a charger. With the increasing ability to control operational settings of a spa unit and/or hot tub and components thereof (e.g., speakers) from an electronic device, easy and convenient access to a charger may be desirable.

### SUMMARY

Disclosed herein is an inductive charging system. The inductive charging systems described herein can include a charging region to allow an electronic device to be charged on or near a spa or other water environment. The charging region may be molded into the spa shell or a separate charging plate for attachment to the spa shell. The inductive charging system may include a charger pad for wirelessly charging an electronic device. The charging plate can be positioned on an exterior portion of a spa shell and the charger can be positioned on an interior portion of the spa shell. In some cases, the charging plate and the charger can be positioned on an exterior portion of the spa shell. The charging plate can include a stand and one or more drains. The stand can prevent the electronic device from slipping. The drains can prevent water from accumulating in the charging region and/or the stand by allowing the water to flow through the drains. An inclined surface of the charging region can beneficially allow water to flow toward and through the drains.

In some embodiments, the inductive charging system can include a spa shell, a charging region, and a charger. The charging region can be positioned on an exterior surface of the spa shell and configured to receive an electronic device. The charger can include a charger housing and a charging pad. In some cases, the charger housing can be configured to receive and secure the charging pad. The charger can be positioned on a rear side of the charging region opposite the electronic device. The charger can be configured to be plugged into spa electronics for power. In some cases, the charging pad can be configured to wirelessly charge the electronic device when the electronic device is positioned on the charging region.

In some cases, the charging region can be on a charging plate configured to be secured to the spa shell. A rear perimeter of the charging plate can be configured to be attached to the spa shell such that a rear side of the electronic device can lean against the spa shell when charging. The charging plate can be configured to receive the charger on a rear side of the charging plate. In some cases, the charging plate can be configured to be positioned on the exterior surface of the spa shell and the charger is configured to be positioned on an interior surface of the spa shell. However, both the charging plate and the charger can be positioned on the exterior surface of the spa shell. In some cases, the charging region can form an angle between 20° and 70° relative to a top surface of the spa shell. The charging region can include a lip configured to prevent the electronic device from slipping. In some cases, the lip can include a slit for drainage. The slit can be centrally located along the lip. The slit can form an angle between 45° and 90° relative to the charging region. The lip can protrude from the charging plate and form an angle between 45° and 90° relative to the charging region.

In some variants, an inductive charging system for a spa can include a charging plate and a charger. The charging plate can be attached to an exterior surface of a spa shell and configured to receive an electronic device. The charging plate can include a lip configured to support the electronic device. The lip can include a drain configured to allow water to drain from the charging plate. The charger can be configured to be coupled to the charging plate. The charging plate can be configured to wirelessly charge the electronic device when the electronic device is positioned on the charging plate.

In some cases, the drain can include a slit configured to allow the water to drain from the charging plate. The lip can extend away from a surface of the charging plate. The lip can form an angle between 45° and 90° relative to the surface of the charging plate. In some cases, the inductive charging system includes a gasket configured to form a seal between the charging plate and the exterior surface of the spa shell. The gasket can create a seal around a perimeter of the charging plate and/or the charger.

In some variants, an inductive charging system can include a charging region molded on an exterior surface of a spa shell and configured to receive an electronic device. The inductive charging system can include a mount. The mount can include a plurality of tabs and be attached to an interior surface of the spa shell. In some cases, the inductive charging system includes a charging pad. The mount can be configured to receive and secure the charging pad. The charging pad can be configured to wirelessly charge the electronic device when the electronic device is positioned on the charging region.

In some cases, the spa shell can include a corner mounted to a spa frame. The charging pad and the mount can be accessible via a gap between the corner and the spa frame. The charging region can form an angle between 20° and 70° relative to a top surface of the spa frame. In some cases, the charging region can include a stand configured to prevent the electronic device from slipping. The stand can include a recess configured to partially receive a bottom face of the electronic device. The spa shell can include one or more drains positioned on opposite ends of the stand. The one or more drains can form an angle between 200° and 270° relative to the charging region. In some cases, the stand can protrude from the spa shell and form an angle between 10° and 40° relative to the charging region. The charging pad can be secured to the mount by opening at least one of the plurality of tabs, inserting the charging pad inside the mount, and closing the least one of the plurality of tabs. The mount can include a plurality of holes configured to receive a plurality of screws for attaching the mount to the spa shell.

### BRIEF DESCRIPTION OF THE DRAWINGS

FIG. 1-8 show an example of an inductive charging system.

FIG. 9A shows an example of a mount for use with an inductive charging system.

FIG. 9B shows another example of a mount for use with an inductive charging system.

FIGS. 10A-10C show examples of charging regions for use with an inductive charging system.

FIG. 11 shows another example of an inductive charging system.

FIG. 12 shows an example of a charging plate for an inductive charging system.

FIGS. 13 and 14 show examples of a charging plate and a charger for an inductive charging system.

FIG. 15 shows a cross section view of the charging plate shown in FIG. 12.

### DETAILED DESCRIPTION

Inductive charging systems and components thereof for spa units and/or hot tubs are described herein. The inductive charging systems can include a charging region on an exterior portion of a spa shell and a charging pad on an interior portion of the spa shell. The charging region can be located on a corner of the spa shell. At least a portion of the spa shell can be positioned between the charging region and the charging pad. In some cases, the charging region can receive and secure an electronic device such as a cellphone and/or a tablet. In use, the inductive charging system can wirelessly charge the electronic device when the electronic device is positioned in the charging region. The charging region can include a lip, also referred herein to as a stand. The lip can beneficially prevent can secure the electronic device in place and prevent the electronic device from slipping. The charging region can include a drain, also referred herein to as a slit, to allow water to flow through the drain and/or prevent water from accumulating in the lip. This can beneficially reduce the risk of the electronic device contacting the water. In some cases, the charging region can include an inclined surface. The inclined surface can facilitate water flow along the drain.

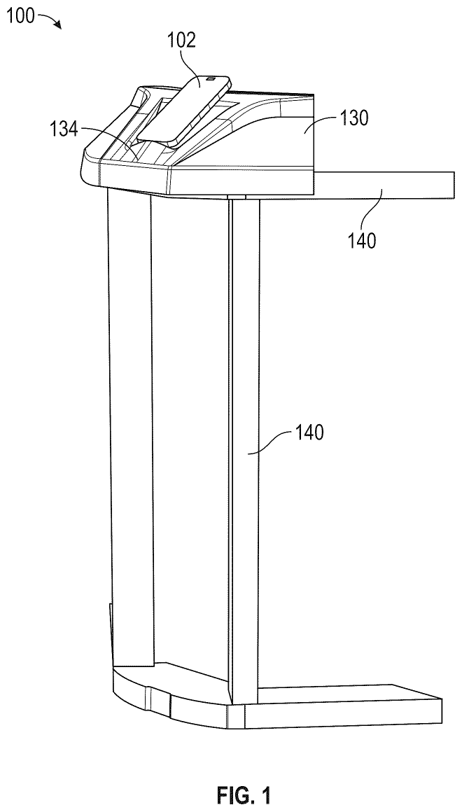

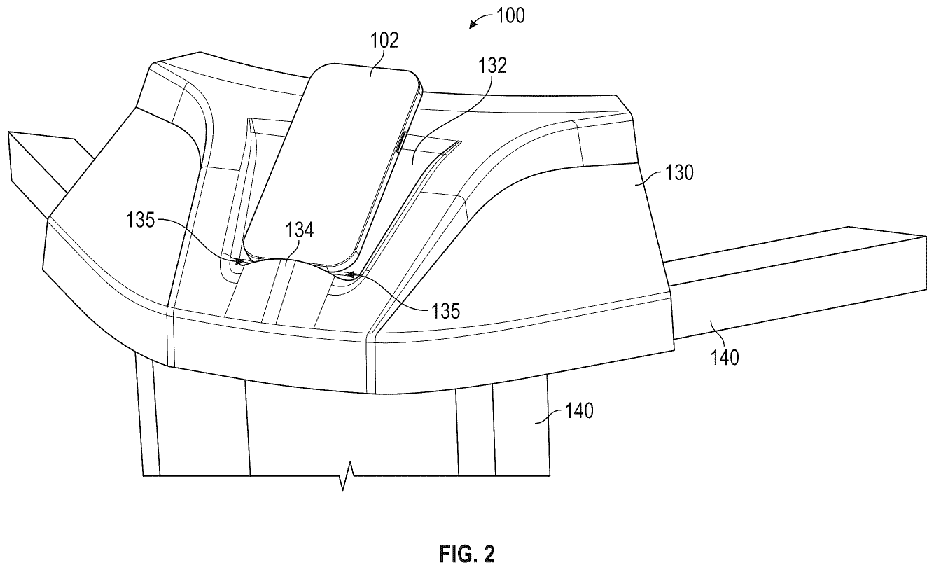

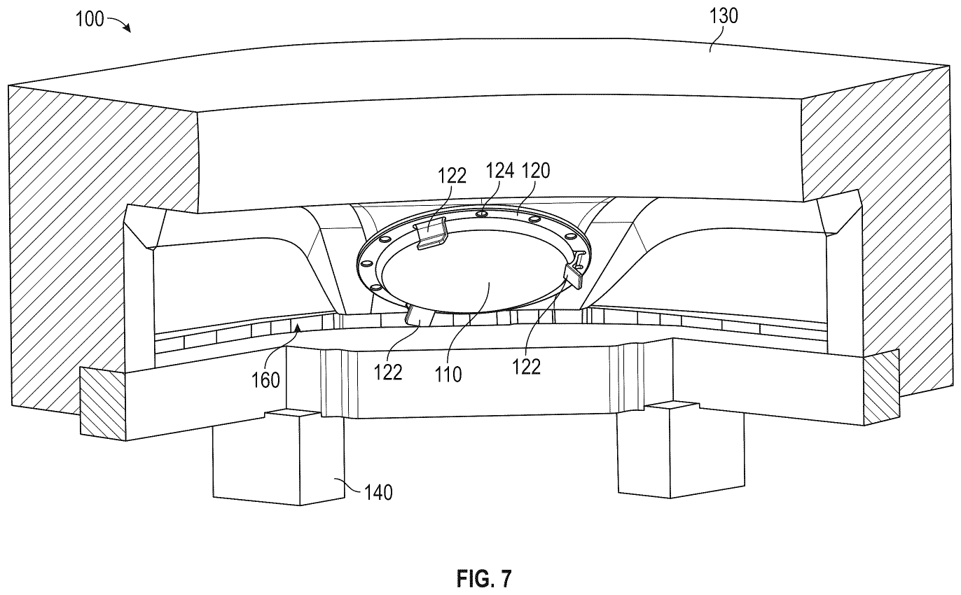

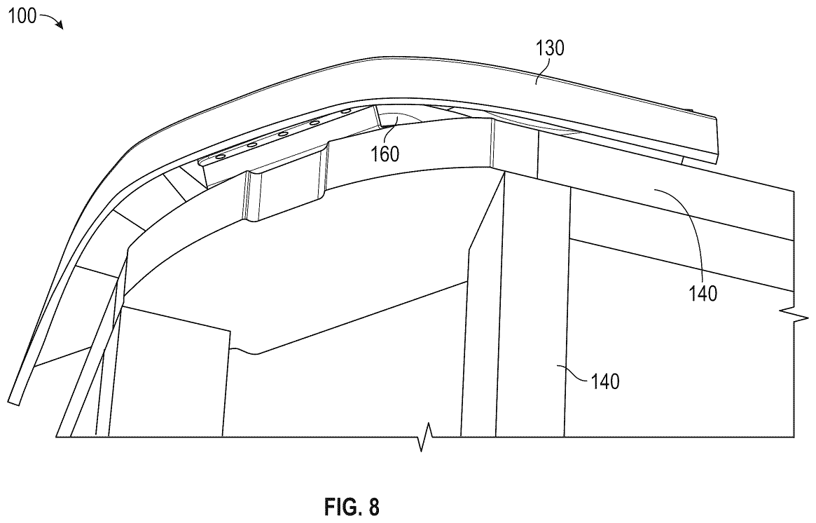

FIGS. 1-8 show an example of an inductive charging system 100. In some cases, the inductive charging system 100 can be used, for example, on spas, hot tubs, or pools to wirelessly charge electronic devices 102 (e.g., cellphones, speakers, lights, or other devices). The inductive charging system 100 can include a charging pad 110 and a mount 120. In some cases, the charging pad 110 and the mount 120 can be attached to an interior surface of a spa shell. For example, the charging pad 110 and the mount 120 can be attached to an interior surface of a spa shell 130, as shown in FIG. 7. For example, the charging pad 110 may be installed in a corner. Although reference is made to the inductive charging system 100 being positioned on a corner of the spa shell 130, the inductive charging system 100 and/or any components thereof can be positioned in other locations of the spa shell 130. For example, the inductive charging system 100 can be positioned anywhere along a rim of the spa and/or a skirt of the spa shell 130. In some cases, the inductive charging system 100 can be preinstalled on a spa unit and/or installed to an existing spa unit.

The charging pad 110 and the electronic device 102 can each include an induction coil. When the electronic device 102 is placed within proximity of the charging pad 110 (e.g., when the electronic device 102 is spaced within 1 mm, 2 mm, 3 mm, 4 mm, 5 mm, 8 mm, 10 mm, 15 mm, 20 mm, 25 mm, 30 mm, etc., from the charging pad 110), the induction coils of the electronic device 102 and the charging pad 110 can create an electromagnetic which can beneficially pass electricity from the charging pad 110 to the electronic device 102. The transferred electricity can be used to charge the battery of the electronic device 102. As such, a thickness of the shell in the region of the charging pad 110 can be less than or equal to about 30 mm, less than or equal to about 25 mm, less than or equal to about 20 mm, less than or equal to about 15 mm, or less than or equal to about 10 mm.

In some cases, all electronic components of the inductive charging system 100, such as the charging pad 110, can be positioned inside a spa shell (e.g., spa shell 130) and away from users reach when users are using the spa unit. For example, the exterior of the spa shell 130, which can be made of an acrylic material, can, in some cases, be devoid of any ports (e.g., charging ports or outlets) metallic components, and/or any electronic components. This can beneficially protect the electronic components of the inductive charging system 100 from water.

The spa shell 130 can be mounted to a spa frame 140, as shown in FIGS. 1-8. In some cases, the spa shell 130 can be molded to include a charging region 132 for charging an electronic device 102. For example, the electronic device 102 could be positioned directly on the shell for charging. The charging region 132 can be located on the exterior surface of the spa shell 130. In some cases, the charging region 132 can be on a corner of the spa frame 140 closest to or being on the same side as a control panel of the spa unit. This can beneficially allow users to reach the charging region 132 and the control panel of the spa unit from the same side of the spa unit. In some cases, the charging region 132 can include a stand 134. The stand 134 can beneficially prevent the electronic device 102 from slipping. In some cases, at least a portion of the spa shell 130 separates the electronic device 102 and the charging pad 110. The charging pad 110 can wirelessly charge the electronic device 102 through the spa shell 130 when the electronic device rests on the charging region 132. This can beneficially allow users to wirelessly charge an electronic device 102 and shield the charging pad 110 from water.

In use, the sloped surface of the spa shell 130 can support an electronic device 102. In some cases, the charging region 132 is sized and positioned to contact an entire face of the electronic device 102. For example, the charging region 132 can be in direct contact with the entirety of the back side of a cellphone. In some cases, the charging region 132 is sized and positioned to contact only a portion of the electronic device 102. For example, the charging region 132 can be in direct contact with only a portion of the back side of a cellphone.

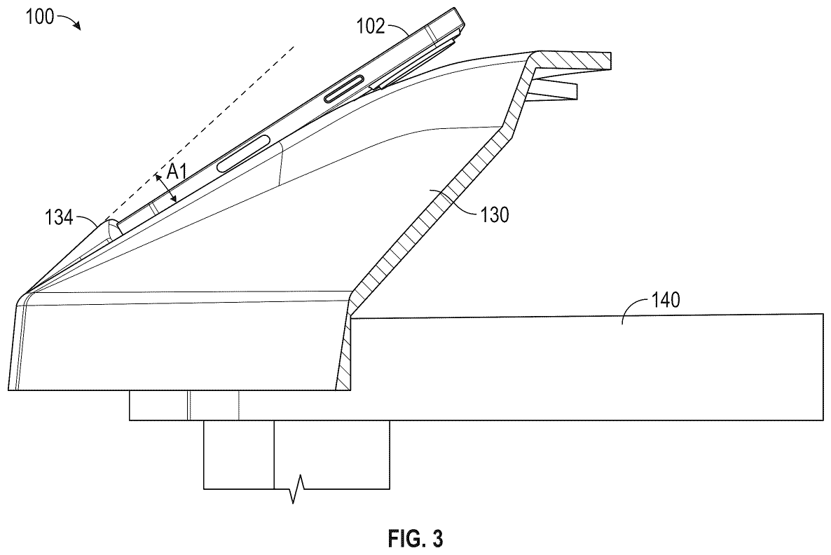

In some cases, the stand 134 can protrude from the spa shell 130 forming an angle. For example, the stand 134 and the charging region 132 can form an angle A1, as shown in FIG. 3. The angle A1 can, in some cases, be at least about 10° and/or less than or equal about 40°. For example, in some cases the angle A1 can be between about 10° and 20°, between about 20° and about 30°, or between about 30° and 40°. In some cases, the stand 134 does not protrude more than 2 cm or more than 1 cm from a surface of the charging region 132. The stand 134 can include a recess (not shown) for partially receiving a portion of the electronic device 102. For example, the recess of the stand 134 can at least partially receive a top portion or a lower portion of a cellphone. The recess can include a flat surface for receiving a bottom face of an electronic device 102.

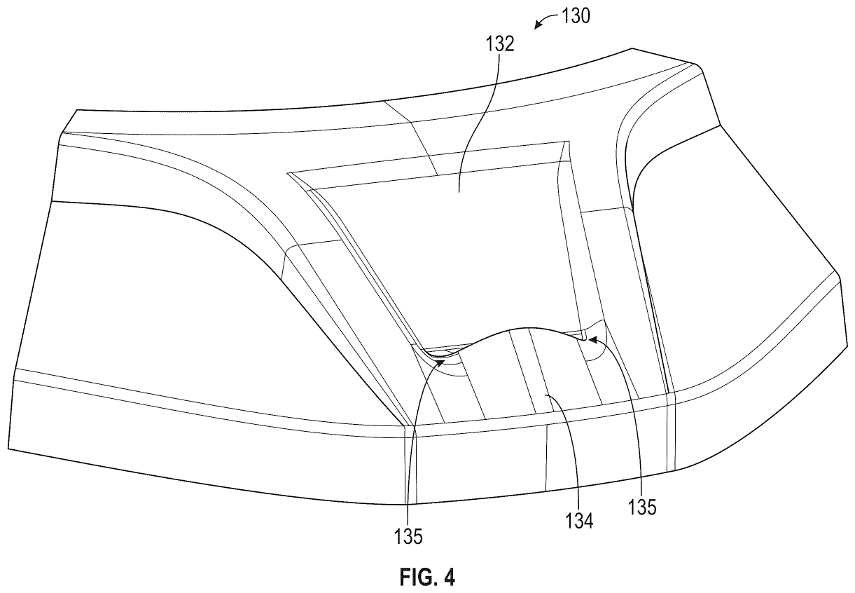

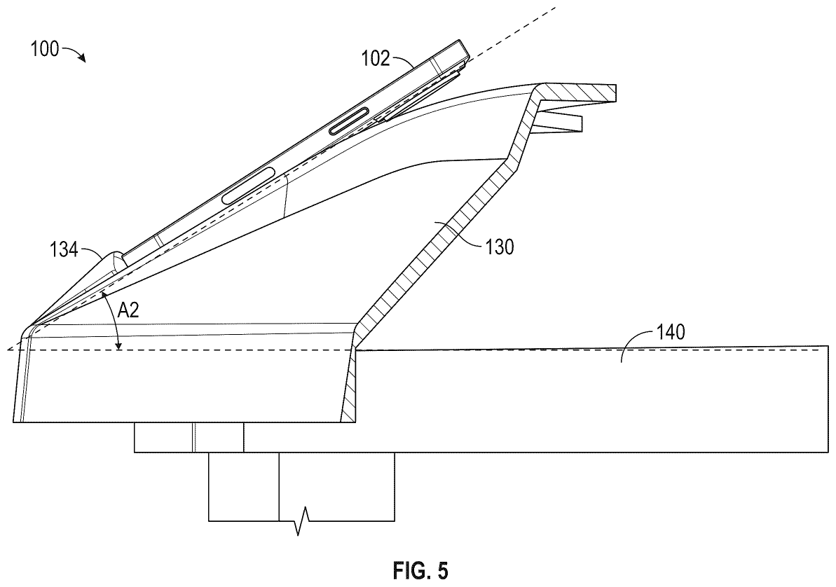

FIG. 4 illustrates the charging region 132 of the spa shell 130 shown in FIGS. 1-3. As illustrated, the charging region 132 is recessed into the spa shell 130 to support the electronic device 102. The charging region 132 can include an inclined surface. For example, the charging region 132 and a top surface of the spa frame 140 can form a non-zero angle A2, as shown in FIG. 5. The angle A2 can, in some cases, be at least about 5° and/or less than or equal to about 70°. For example, in some cases the angle A2 can be between about 5° and 10°, between about 20° and 40°, between about 30° and 50°, between 40° and 60°, or between about 50° and 70°. The charging region 132 may have a variable incline. As shown in FIG. 5, the spa shell 130 is gradually tapered toward the inclined surface of the charging region 132. The inclined surface of the charging region 132 can beneficially allow faster and more efficient draining. In some cases, the angle A2 can be about 0° and/or less than or equal to about 5° so that the charging region 132 includes a non-inclined surface and/or an almost non-inclined surface.

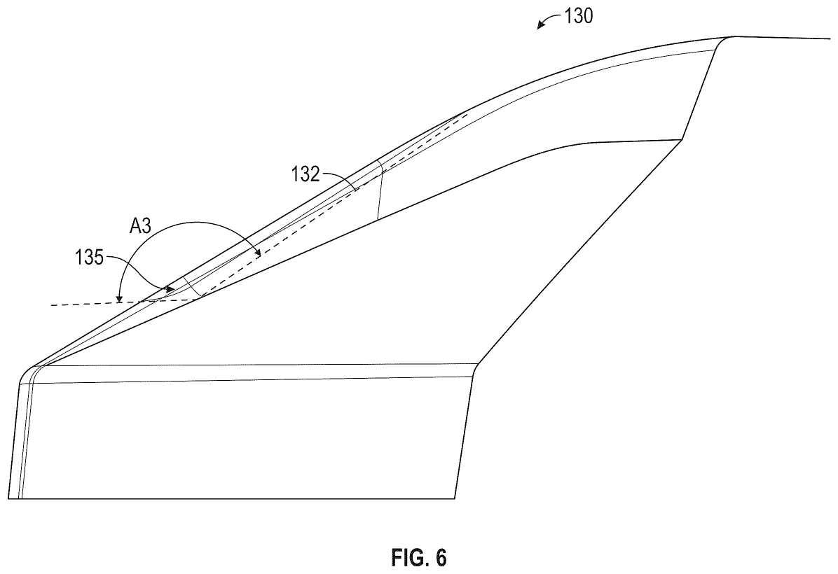

The spa shell can include one or more drains 135, which can beneficially prevent the accumulation of water at or near the charging region 132 and/or the stand 134. In some cases, the drains 135 can be molded into the structure of the spa shell 130 and be positioned on opposite ends of the stand 134. For example, each drain 135 can be shaped as a concavity on one or both sides of the convex stand 134. The convex shape of the stand 134 allows water to flow toward the drains 135. The drains 135 can be open to an exterior-most surface of the spa shell 130 to allow water to flow out of the charging region 132. The surface of the spa shell 130 adjacent the drains 135 can be sloped to channel water away from the charging region 132. In some cases, the drains 135 and the charging region 132 form an angle A3 as shown in FIG. 6 (which shows a cross section view of the spa shell 130 in FIG. 1-5). The angle A3 can, in some cases, be at least about 200° and/or less than or equal to about 270°. For example, in some cases the angle A3 can be between about 200° and 240°, between about 230° and 250°, between 240° and 260°, or between about 250° and 270°. Each of the drains 135 may have a variable incline. In some cases, the angle A3 is about 140°. In some cases, the drains 135 can slope down relative to a horizontal plane to further facilitate draining. For example, the drains 135 can slope down at a non-zero angle relative to horizontal so water does not get trapped in the charging region. For example, the angle may be at least about 3 degrees. The angle may be greater than about 0° and/or less than or equal to about 10°, such as between about 1° and 3°, between about 2° and 4°, between about 3° and 5°. between about 4° and 6°, or between 5° and 7° from a horizontal plane.

As shown in FIG. 7, the mount 120 can be attached to an interior surface of a spa shell, such as spa shell 130. The mount 120 can be attached to the spa shell 130 using, for example, adhesive, magnets, or any suitable attachment means. In some cases, the mount 120 can be glassed-in to the spa shell 130.

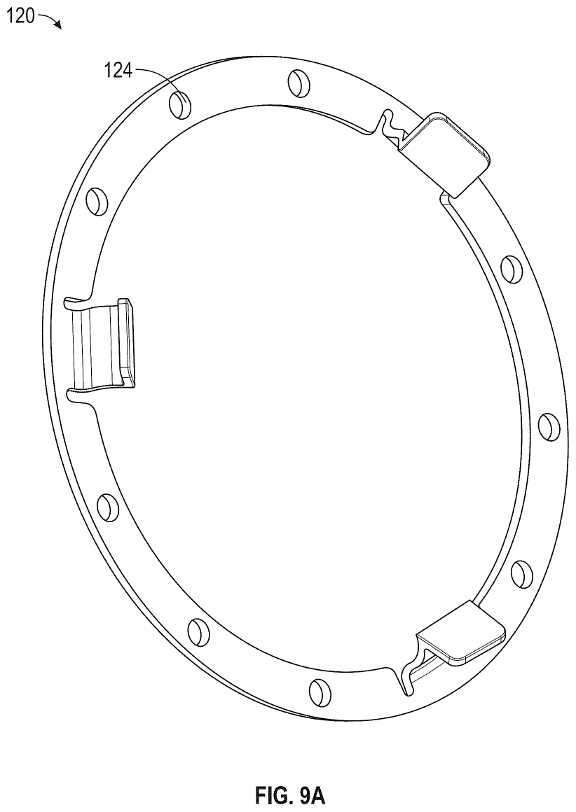

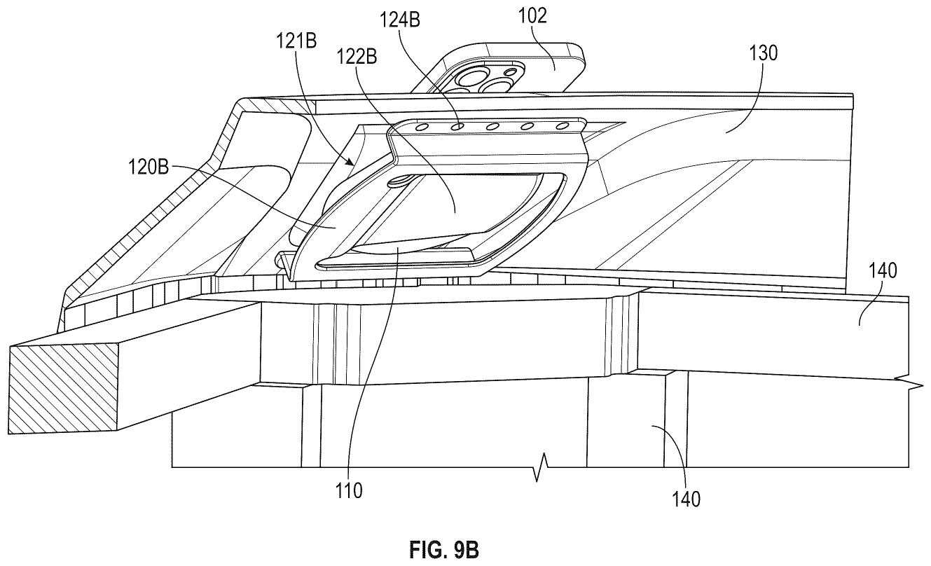

The mount 120 can include a circular outer ring with an opening extending therethrough. The mount 120 can include one or more tabs 122 and/or a plurality of holes 124 positioned around a circumference of the outer ring, as shown in FIG. 9A. The one or more tabs 122 can each be opened and closed by bending the tabs 122 relative to the circular outer ring. The plurality of holes 124 can be used to secure the mount 120 to the spa shell 130, for example by receiving a fastener or bonding material.

In some cases, the mount 120 can receive and secure the charging pad 110. The charging pad 110 can be secured to the mount 120 by opening at least one of the tabs 122, inserting the charging pad into the mount 120, and closing the tabs 122. The charging pad 110 can be released from the mount 120 by opening at least one of the tabs 122 and pulling the charging pad 110 from the mount 120. In some cases, the charging pad 110 and/or mount 120 can be accessible from the exterior of the spa unit. For example, the interior surface of the spa shell 130 (including the surface where the charging pad 110 and/or mount 120 are positioned) can be accessible via a gap 160 between the spa shell 130 and the spa frame 140. This can beneficially allow users to conveniently secure or release the charging pad 110 from the mount 120. In some cases, the gap can be accessed by removing a panel, such as corner panel, of a spa unit. The corner panel can beneficially provide additional protection for the electronic components of the inductive charging system 100, such as the charging pad 110, from the exterior and prevent water from contacting the charging pad 110.

In some cases, the charging pad 110 can be positioned on an exterior surface of a spa shell, such as spa shell 130. The charging pad can be positioned on, for example, a non-flat surface of a spa shell to allow water to drain. To prevent electronic devices from slipping off the spa shell, the spa shell can include non-skid surfaces such a neoprene and/or silicone surface.

The charging pad 110 can be mounted to an exterior surface of the spa shell 130 by drilling a hole on the exterior surface of the spa shell 130, placing the charging pad 110 in the drilled hole, and securing the charging pad 110 in the drilled hole. The hole can match or substantially match the dimensions and/or a shape of the charging pad 110. The charging pad 110 can be secured to the drilled hole by screwing or gluing the charging pad 110 to the edges of the drilled hole. In some cases, the charging pad 110 can include a sealing flange. The flange can beneficially secure the charging pad 110 inside the drilled hole. The sealing flange can rest on an edge surrounding the drilled hole. In some cases, the sealing flange can include adhesive to facilitate sealing of the sealing flange to the spa shell 130. For example, the sealing flange can include neoprene, or other synthetic rubber, with an adhesive layer. When mounted to the spa shell 130, the adhesive layer of the sealing flange can face the exterior surface of the spa shell 130 to allow the adhesive layer to adhere to the spa shell 130. The neoprene and adhesive layer can beneficially prevent water from flowing through the drilled hole. The charging pad 110 and the exterior surface of the spa shell 130 can be flush when the charging pad 110 is secured in the drilled hole.

FIG. 9B shows an example of an alternative mount 120B. The mount 120B can include an opening 121B, one or more tabs 122B, and a plurality of holes 124B.

The mount 120B can be attached to an interior surface of a spa shell using, for example, adhesive, magnets, or any suitable attachment means. In some cases, the mount 120B can be glassed-in to the spa shell. The plurality of holes 124B can be used to secure the mount 120B to the spa shell 130, for example by receiving a fastener or bonding material.

The tab of the 122B can be opened and closed by bending the tab 122B. In some cases, the tab 122B is biased in a closed position. That is, the tab 122B can stay in closed position unless force is applied to transition the tab 122B to an open position. The tab 122B can return to a closed position if force is not applied to maintain the tab 122B in an open position.

In some cases, the mount 120B can receive and secure the charging pad 110. The charging pad 110 can be secured to the mount 120B by opening the tab 122B (e.g., in a direction opposite to the spa shell 130), inserting the charging pad 110 into the mount 120 via the opening 121B, and closing the tab 122B (e.g., by releasing the tab 122B). The charging pad 110 can be released from the mount 120B by opening the tab 122B and pulling the charging pad 110 from the mount 120B. In some cases, the charging pad 110 and/or mount 120B, like the charging pad 110 and the mount 120, via the gap 160 between the spa shell 130 and the spa frame 140.

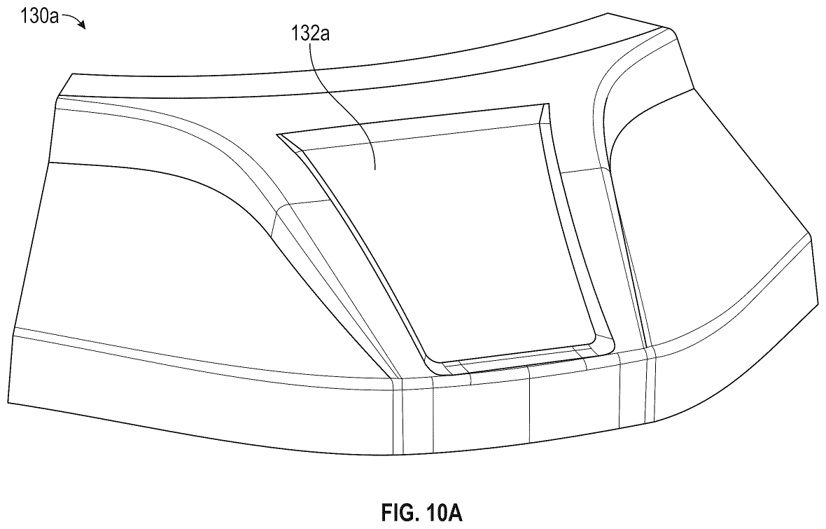

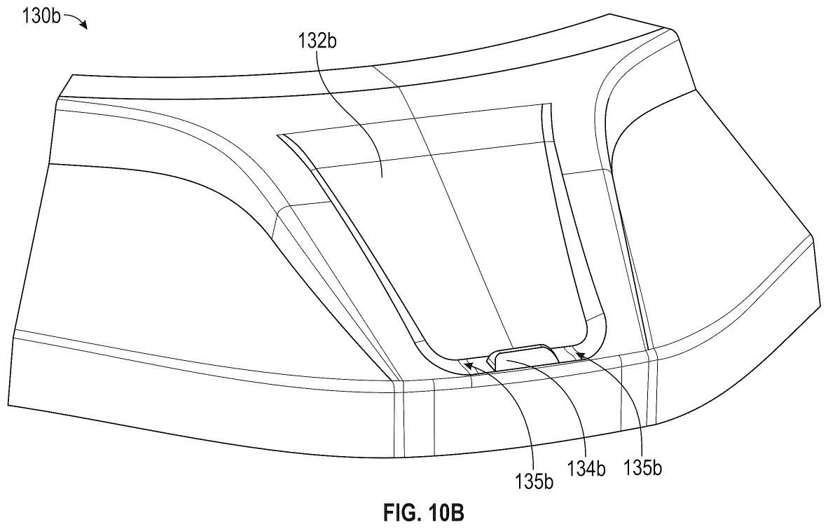

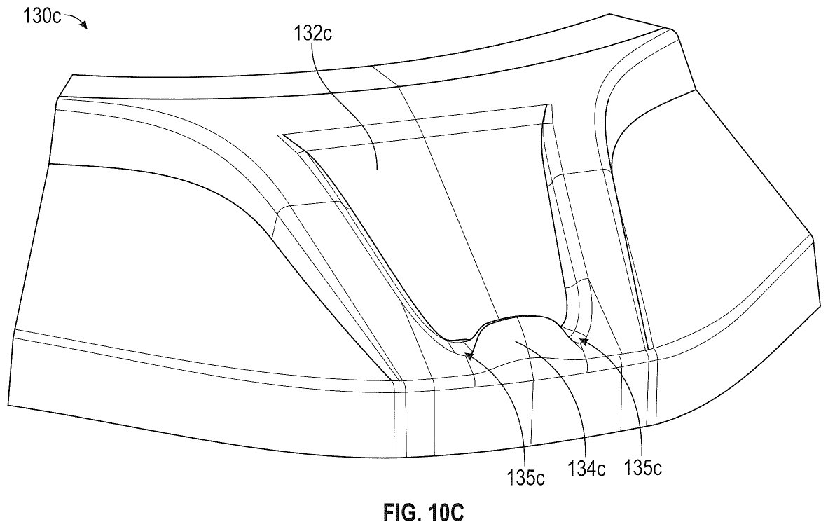

FIGS. 10A-10C show different examples of spa shell corners for use with an inductive charging system. For example, FIG. 10A shows an example of a spa shell 130a including a charging region 132a. Unlike charging region 132 of the spa shell 130 shown in FIGS. 1-8, the charging region 132a has a relatively planar bottom surface instead of a convex stand. The lower corners of the charging region 132a can be shaped, e.g., sloped downward and/or outward, to allow water to drain away from the charging region 132b.

A stand, such as stand 134, can be attached to spa shell corners not including a stand. For example, and as shown in FIG. 10B, a spa shell 130b can include a charging region 132b, drains 135b, and a removable stand 134b. The stand 134b can be attached to the spa shell 130b by, for example, drilling a hole on the spa shell 130b and screwing the stand 134b to the drilled hole (not shown).

Lastly, FIG. 10C shows an example of a spa shell 130c including a charging region 132c, a stand 134c, and drains 135c. The stands 134b, 134c can protrude from the spa shell 130 at an angle from about 10° to about 40°. For example, in some cases the angle can be between about 10° and 20°, between about 20° and about 30°, or between about 30° and 40°. Like the charging region 132 and the spa frame 140 described in relation to FIGS. 1-8, the charging regions 132a, 132b, 132c, can form an angle with a top surface of a spa frame (such as angle A2). The angle can be between about 20° and about 70°. For example, in some cases the angle can be between about 20° and 40°, between about 30° and 50°, between 40° and 60°, or between about 50° and 70°. In some cases, an angle, such as angle A3 described in relation to FIGS. 1-8, between the drains 135 c and the charging region 132 c can be at least about 200° and/or less than or equal to about 270°. For example, in some cases the angle can be between about 200° and 240°, between about 230° and 250°, between 240° and 260°, or between about 250° and 270°. The angle can be greater than the angle A3 between the drains 135 and the charging region 132 of the spa shell 130. For example, the angle can be about 150°.

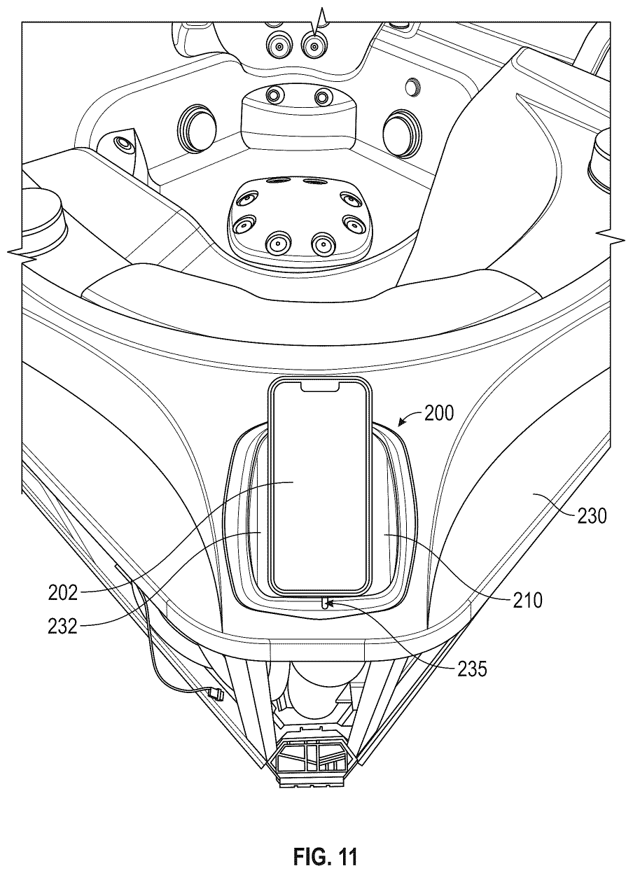

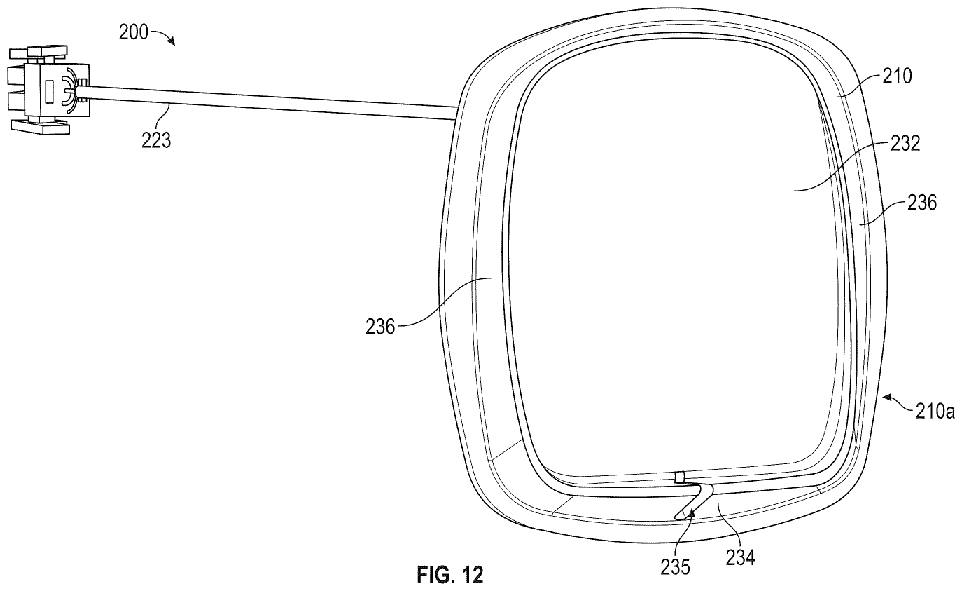

FIGS. 11-15 show an inductive charging system 200. The inductive charging system 200 can include any features of the above-described charging system. The inductive charging system 200 can include at least some aspects of the inductive charging system 100. For instance, the inductive charging system 200 can be used in a water environment, for example, on spas, bath tubs hot tubs, or pools to wirelessly charge electronic devices 202 (e.g., cellphones, speakers, lights, or other devices).

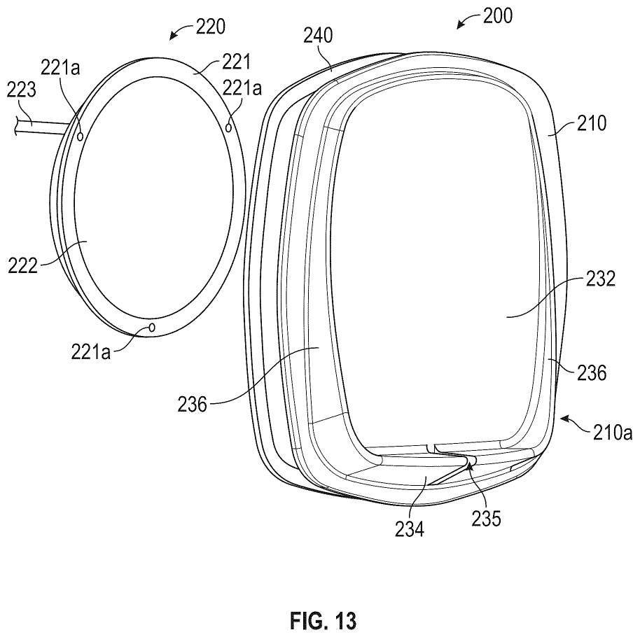

The inductive charging system 200 can include a charging region, which may be molded to the spa shell as described above or separately attached to the spa shell. The inductive charging system 200 can include a charging plate 210, a charger 220, and/or a gasket 240, as shown in FIG. 13. The charging plate 210 can be made of a plastic material and/or any other suitable material. In some cases, the charging plate 210 and the charger 220 can be secured to a spa shell. For example, the charging plate 210 can be attached to an exterior portion of a spa shell 230 and the charger 220 can be attached to an interior portion of the spa shell 230. As another example, the charger 220 can be secured to the charging plate 210, and both the charger 220 and the charging plate 210 may be secured to the exterior portion of the spa shell 230. In some cases, the charging plate 210 may be installed in a corner of the spa shell 230. The charger 220 can include a charger housing 221 and a charging pad 222. The charging pad 222 can be in communication with a source of power (e.g., a spa controller, a power outlet, etc.) via a power a power adapter 223 cable, for example through the spa electronics. Although reference is made to the inductive charging system 200 being positioned on a corner of the spa shell 230, the inductive charging system 200 and/or any components thereof can be positioned in other locations of the spa shell 230. For example, the inductive charging system 200 can be positioned anywhere along a rim and/or a skirt of the spa shell 230. In some cases, the inductive charging system 200 can be preinstalled on a spa unit and/or installed to an existing spa unit.

Like the charging pad 110 and the electronic device 102 of the inductive charging system 100, the charging pad 222 and/or the electronic device 202 can each include an induction coil. When the electronic device 202 is placed within proximity of the charging plate 210 (e.g., when the electronic device 202 is spaced within 1 mm, 2 mm, 3 mm, 4 mm, 5 mm, 8 mm, 10 mm, 15 mm, 20 mm, 25 mm, 30 mm, etc., from the charging plate 210), the induction coils of the electronic device 202 and the charging pad 222 can create an electromagnetic field which can beneficially transmit electricity from the charging pad 222 to the electronic device 202. The electricity can be used to charge the battery of the electronic device 202. As such, a thickness of the shell in the region of the charging plate 210 can be less than or equal to about 30 mm, less than or equal to about 25 mm, less than or equal to about 20 mm, less than or equal to about 15 mm, or less than or equal to about 10 mm.

In some cases, at least some of the components of the inductive charging system 200, such as the charger 220, can be positioned inside a spa shell (e.g., the spa shell 230) and away from users' reach when users are using the spa unit. For example, the exterior of the spa shell 230, which can be made of an acrylic material, can, in some cases, be devoid of any ports (e.g., charging ports or outlets), metallic components, and/or any electronic components. This can beneficially protect the electronic components of the inductive charging system 200 from water.

The charging plate 210 can be attached to an exterior portion of the spa shell 230. The charging plate 210 can include a front portion 210a and a rear portion 210b. The rear portion 210b can be secured to and rest against the spa shell, for example using glues or screws. The rear portion 210b can be secured to the spa shell such that at least a rear perimeter of the charging plate 210 is secured to the spa shell. The front portion 210a can include a charging region 232 for charging an electronic device 202. For example, the electronic device 202 can be positioned directly on the charging region 232 for charging. In some cases, the charging plate can be attached to a corner of the spa shell 230 closest to or being on the same side as a control panel of the spa unit. This can beneficially allow users to reach the charging region 232 and the control panel of the spa unit from the same side of the spa unit. In some cases, the charging plate 210 can include a lip 234, also referred herein to as a stand. The lip 234 can beneficially prevent the electronic device 202 from slipping. In some cases, at least a portion of the spa shell 230 separates the charging plate 210 and the charger 220. The gasket 240 can be positioned between the charging plate 210 and an exterior surface of the spa shell 230. The gasket 240 can create a seal around an edge of the charging plate 210. This can beneficially prevent water from contacting the charger 220. The charger 220 can wirelessly charge the electronic device 202 through the spa shell 230 and/or the charging plate 210 when the electronic device rests on the charging region 232. This can beneficially allow users to wirelessly charge an electronic device 202 while shielding the charger 220 from water.

The charging plate 210 can include one or more sidewalls 236. The one or more sidewalls 236 can protrude from the charging plate 210. In some cases, the charging plate 210 can include two sidewalls 236 protruding from opposite sides of the charging plate 210. The sidewalls 236 can beneficially prevent the electronic device 202 from falling off the charging region 232 of the charging plate 210.

In some cases, the charging plate 210 and the charger 220 can be positioned on an exterior portion of the spa shell 230. For example, the charger 220 can be secured to a corner of the spa shell 230 and the charging plate 210 can be secured to the charger 220. The charger 220 and/or the charging plate 210 can be secured to the spa shell 230 using, for example, adhesive. However, any suitable means can be used to secure the charger 220 and/or the charging plate 210 to the spa shell 230 (e.g., adhesive, glue, screws, etc.). In some cases, the charging plate 210 and the charger 220 can be secured to each other before securing the charger 220 to the spa shell 230. The charging plate 210 and the charger 220 can be secured to each other as described below. In some cases, the gasket can be positioned between the charging plate 210 and the charger 220. The spa shell 230 can include a hole to index the charging plate 210 and/or the charger 220. The power adapter cable 223 can extend through the hole on the spa shell 230. This can beneficially allow the power adapter cable 223 to be connected to a source of power (e.g., the spa electronics, and/or a harness thereof).

In use, a sloped surface of the charging plate 210 can support the electronic device 202. In some cases, the charging region 232 of the charging plate 210 can be sized and positioned to contact an entire face of the electronic device 202. For example, the charging region 232 can be in direct contact with the entirety of the back side of a cellphone. In some cases, the charging region 232 is sized and positioned to contact only a portion of the electronic device 202. For example, the charging region 232 can be in direct contact with only a portion of the back side of a cellphone.

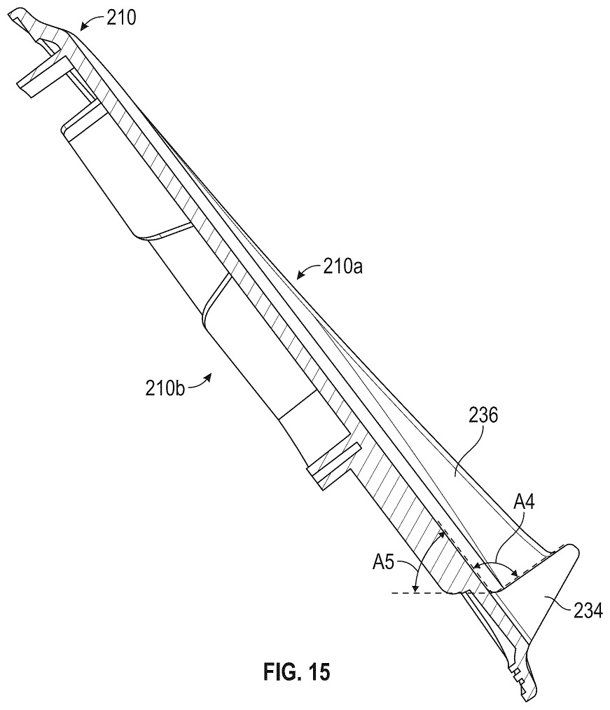

In some cases, the lip 234 can protrude from the charging plate 210 forming an angle. For example, the lip 234 and the charging region 232 can form an angle A4, as shown in FIG. 15. The angle A4 can, in some cases, be at least about 45° and/or less than or equal about 90°. For example, in some cases the angle A4 can be between about 45° and 60°, between about 60° and about 75°, or between about 75° and 90°. In some cases, the lip 234 does not protrude more than 2 cm or more than 1 cm from a surface of the charging region 232. The lip 234 can include a recess (not shown) for partially receiving a portion of the electronic device 202. For example, the recess of the lip 234 can at least partially receive a top portion or a lower portion of a cellphone. The recess can include a flat surface for receiving a bottom face of an electronic device 202.

The charging region 232 can recessed into the spa shell 230 to support the electronic device 202. The charging region 232 can include an inclined surface. For example, the charging region 232 and a top surface of the spa shell 230 can form a non-zero angle A5. The angle A5 formed by the charging region 232 and the top surface of the spa shell 230 can be similar or identical to the angle A2 formed by the charging region 132 and the top surface of the spa frame 140 of the inductive charging system 100. For instance, the angle A5 can be at least about 5° and/or less than or equal to about 70°. For example, in some cases the angle A5 can be between about 5° and 20°, between about 20° and 40°, between about 30° and 50°, between 40° and 60°, or between about 50° and 70°. The charging region 232 may have a variable incline and/or a constant incline. The inclined surface of the charging region 232 can beneficially allow faster and more efficient draining. In some cases, the angle A5 can be about 0° and/or less than or equal to about 5° so that the charging region 232 includes a non-inclined surface and/or almost non-inclined surface.

The charging plate 210 can include one or more drains 235, which can beneficially prevent the accumulation of water at or near the charging region 232 and/or the lip 234. In some cases, the drains 235 can be molded into the structure of the charging plate 210. The drain 235 can be positioned along the lip 234. For example, the drain 235 can include a slit along the lip 234. The inclined surface of the charging region 232 can allow water to flow toward the drains 235. The drains 235 can be open to an exterior-most surface of the spa shell 230 to allow water to flow out of the charging region 232. The surface of the spa shell 230 adjacent the drains 235 can be sloped to channel water away from the charging region 232. Each of the drains 235 may have a variable incline. In some cases, the drains 235 can slope down relative to a horizontal plane to further facilitate draining. For example, the drains 235 can slope down at a non-zero angle relative to horizontal so water does not get trapped in the charging region 232. Although reference is made to the charging plate 210 including a single drain 235, the charging plate 210 can include more than one drain 235 (e.g., two, three, four, five, etc., drains).

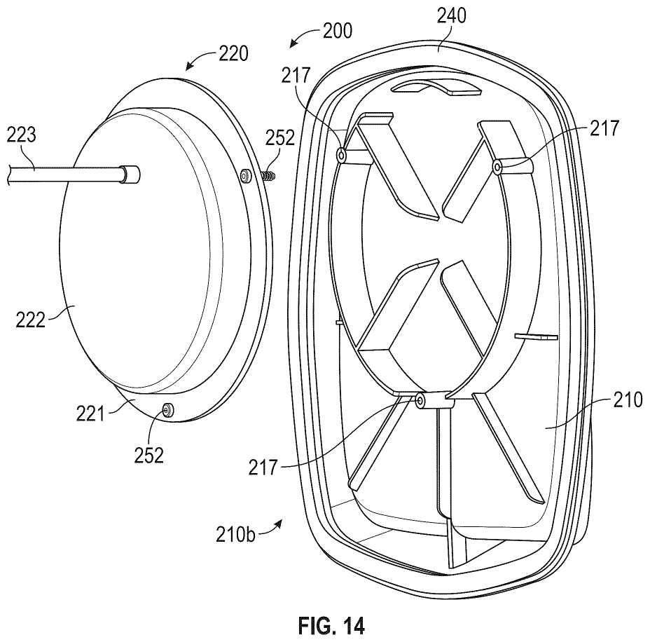

As shown in FIG. 14, the charger 220 can be attached to the charging plate 210. The charger 220 can be secured to the charging plate 210 using, for example, screws, adhesive, magnets, or any suitable attachment means. In some cases, the rear portion 210b of the charging plate 210 can include a plurality of screw holes 217. The charger housing 221 can include a plurality of holes 221a. The plurality of holes 221a can be used to secure the charger 220 to the charging plate 210. For example, the plurality of screw holes 217 of the charging plate 210 and the plurality of holes 221a of the charger housing 221 can be aligned to receive and secure a plurality of screws 252. In some cases, The plurality of holes 221a and/or the plurality of screw holes 217 can be aligned with a plurality of holes (now shown) of the spa shell 230. This can allow the screws 252 to extend though the spa shell 230 when the charging plate 210 and the charger 220 are secured to each other.

In some cases, the charging plate 210 and the charger 220 can be attached to each other using a mount and/or one or more tabs similar to and/or identical to the mount 120, the mount 120B, the tabs 122, and/or the tabs 122B which are describe in relation to FIGS. 1-9B. For instance, a rear portion of the charging plate 210 can include a mount including one or more tabs for receiving and/or securing the charger 220 to the charging plate 210.

Although the embodiments of the inductive charging systems described herein are described and/or shown as being positioned on an upper and/or exterior surface of a spa shell, the inductive charging systems and/or any components thereof can be positioned inside the spa cabinet or shell. For instance, the inductive charging system 100 and/or the inductive charging system 200 can be positioned inside a compartment of the spa cabinet or spa shell. The compartment can be sealed from the exterior environs thereby providing additional protection to the inductive charging system 100, the inductive charging system 200, and/or an electronic device. The compartment can be sealed from the exterior environs using a door and/or any suitable means. When closed, the door can form a seal between the compartment and the exterior of the spa shell. In some cases, the compartment can include a chamber formed within a sidewall of the spa cabinet or shell. At least some of the components of the inductive charging system 100 and/or the inductive charging system 200 can be positioned within the chamber.

### Terminology

Although certain embodiments and examples are disclosed herein, inventive subject matter extends beyond the examples in the specifically disclosed embodiments to other alternative embodiments and/or uses, and to modifications and equivalents thereof. While we have described and illustrated in detail embodiments of An inductive charging system, it should be understood that our inventions can be modified in both arrangement and detail. For example, the features described herein can be incorporated into any type of spa or hot tub. Thus, the scope of the claims appended hereto is not limited by any of the particular embodiments described above. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

1. An inductive charging system comprising:
a spa shell;
a charging region positioned on an exterior surface of the spa shell and configured to receive an electronic device; and
a charger comprising a charger housing and a charging pad, the charger housing configured to receive and secure the charging pad, the charger configured to be positioned on a rear side of the charging region opposite the electronic device, the charger configured to be plugged into spa electronics for power;
wherein the charging pad is configured to wirelessly charge the electronic device when the electronic device is positioned on the charging region.

2. The inductive charging system of claim 1, wherein the charging region is on a charging plate configured to be secured to the spa shell.

3. The inductive charging system of claim 2, wherein a rear perimeter of the charging plate is configured to be attached to the spa shell.

4. The inductive charging system of claim 2, wherein the charging plate is configured to receive the charger on a rear side of the charging plate.

5. The inductive charging system of claim 2, wherein the charging plate is configured to be positioned on the exterior surface of the spa shell and the charger is configured to be positioned on an interior surface of the spa shell.

6. The inductive charging system of claim 1, wherein the charging region forms an angle between 20° and 70° relative to a top surface of the spa shell.

7. The inductive charging system of claim 1, wherein the charging region comprises a lip configured to prevent the electronic device from slipping.

8. The inductive charging system of claim 7, wherein the lip comprises a slit for drainage.

9. (canceled)

10. (canceled)

11. The inductive charging system of claim 7, wherein the lip protrudes from the charging plate and forms an angle between 45° and 90° relative to the charging region.

12. An inductive charging system for a spa, the inductive charging system comprising:
a charging plate configured to be attached to an exterior surface of a spa shell and configured to receive an electronic device, the charging plate comprising a lip configured to support the electronic device, the lip comprising a drain configured to allow water to drain from the charging plate; and
a charger configured to be coupled to the charging plate;
wherein the charging plate is configured to wirelessly charge the electronic device when the electronic device is positioned on the charging plate.

13. The inductive charging system for a spa of claim 12, wherein the drain comprises a slit configured to allow the water to drain from the charging plate.

14. (canceled)

15. (canceled)

16. The inductive charging system of claim 12, further comprising a gasket configured to form a seal between the charging plate and the exterior surface of the spa shell, wherein the gasket creates a seal around a perimeter of the charging plate.

17. (canceled)

18. An inductive charging system comprising:
a charging region molded on an exterior surface of a spa shell and configured to receive an electronic device;
a mount comprising a plurality of tabs and attached to an interior surface of the spa shell; and
a charging pad;
wherein the mount is configured to receive and secure the charging pad;
wherein the charging pad is configured to wirelessly charge the electronic device when the electronic device is positioned on the charging region.

19. The inductive charging system of claim 12, wherein the spa shell comprises a corner mounted to a spa frame.

20. The inductive charging system of claim 19, wherein the charging pad and the mount are accessible via a gap between the corner and the spa frame.

21. The inductive charging system of claim 19, wherein the charging region forms an angle between 20° and 70° relative to a top surface of the spa frame.

22. The inductive charging system of claim 12, wherein the charging region comprises a stand configured to prevent the electronic device from slipping.

23. The inductive charging system of claim 22, wherein the stand comprises a recess configured to partially receive a bottom face of the electronic device.

24. The inductive charging system of claim 22, wherein the spa shell further comprises one or more drains positioned on opposite ends of the stand, and wherein the one or more drains form an angle between 200° and 270° relative to the charging region.

25. (canceled)

26. The inductive charging system of claim 25, wherein the stand protrudes from the spa shell and forms an angle between 10° and 40° relative to the charging region.

27. (canceled)

28. (canceled)
